(19) United States
(12) Patent Application Publication
(10) Pub. No.: US 2025/0108441 A1
(43) Pub. Date: Apr. 3, 2025

(54) Drill Chuck with Hardened Body

(71) Applicants: Jacobs Chuck Manufacturing (Suzhou) Company, Ltd., Suzhou (CN); Apex Brands, Inc., Apex, NC (US)

(72) Inventor: XingLu Li, Suzhou (CN)

(21) Appl. No.: 18/832,524

(22) PCT Filed: Jan. 24, 2022
(86) PCT No.: PCT/CN2022/073486

§ 371 Date: Jul. 24, 2024

(51) Int. Cl. B23B 31/12

(52) U.S. Cl. CPC B23B 31/1238

(57) ABSTRACT

A chuck for use with a powered driver having a rotatable drive shaft is provided. The chuck may include a body comprising a forward bore, a plurality of passageways, and a posterior bore. A plurality of jaws may be movably disposed within the plurality of passageways. The posterior bore may be disposed in a posterior section of the body and the posterior bore may be configured to receive the drive shaft to couple the drive shaft with the chuck. A hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

### TECHNICAL FIELD

Example embodiments generally relate to chucks for use with rotating power drivers, such as electric or pneumatic power drivers.

### BACKGROUND

Power drivers (e.g., hand drivers, press drivers, lathes, etc.) are commonly used in a variety of settings, such as manufacturing, wood working, repair work, and the like. Power drivers are often coupled with a bit (or end effector) that designed for a specific task. The large variety of bits on the market gives the power driver a wide range of applications. Some example bits include twist drills, burr drills, screw bits, nut bits, mounted grinding stones, and other cutting, abrading, or fastener engaging bits. Each bit may include a shank, and the shanks may be different both in size and shape (e.g., having varying diameters and cross sectional shapes, such as circular or polygon cross sectional shapes). As such, to couple the bit to a power driver, an adjustable chuck can be used to secure the bit to the power driver. The chuck may be attached to a drive shaft in the form of a spindle of the driver or to an arbor that, in turn, couples to the driver.

Because the chuck is coupled between the bit and the power driver, the chuck is subjected to many torques and forces when the power driver is being used, particularly during sudden stops and starts. As power driver technology evolves and new applications for power drivers arise, there is an increased demand for higher torques, which requires a power driver that offers a higher power to provide the high torques to reach those speeds or decelerate from those speeds. With higher torque power drivers it has been found that run-out (run-out being an inaccuracy of a rotating mechanical system, specifically that the tool or shaft does not rotate exactly in line with the main axis) may increase to undesirable levels. Users desire both higher torques and low run-out in power drivers with adjustable chucks. Accordingly, innovation to address the technical problem of high run-out with higher torque power drivers in the context of chucks and power drivers is desired.

### BRIEF SUMMARY OF SOME EXAMPLES

According to some example embodiments, a chuck for use with a powered driver having a rotatable drive shaft is provided. The chuck may comprise a plurality of jaws and a body comprising a forward bore, a plurality of passageways, and a posterior bore. The plurality passageways may intersect into the forward bore and the plurality of jaws may be movably disposed within the plurality of passageways. The posterior bore may be disposed in a posterior section of the body and the posterior bore may be configured to receive the drive shaft to couple the drive shaft with the chuck. The chuck may also comprise a nut operably coupled to the jaws such that rotation of the nut relative to the body moves the jaws relative to the body in an opening or closing direction. Additionally, a hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

According to some example embodiments, body for a chuck for use with a powered driver having a rotatable drive shaft is provided. The body may comprise a forward bore and a plurality of passageways intersecting into the forward bore to receive chuck jaws. The body may further comprise a posterior bore disposed in a posterior section of the body, and the posterior bore may be configured to receive the drive shaft to couple the drive shaft with the chuck. The body may define a posterior face that surrounds the posterior bore. A hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

According to some example embodiments, a power driver is provided. The power driver may comprise a drive motor and a drive shaft coupled to the drive motor to be rotationally driven by the drive motor. The power driver may further comprise a chuck coupled to the drive shaft to be rotationally driven by the drive motor via the drive shaft. The chuck may comprise a body. The body may comprise a posterior bore disposed in a posterior section of the body. The posterior bore may be configured to receive the drive shaft to couple the drive shaft to the chuck. A hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a longitudinal view, partly in section, of a chuck in accordance with an example embodiment;

FIG. 2 illustrates an exploded view of a chuck as shown in FIG. 1 in accordance with an example embodiment;

FIG. 3 illustrates an exploded view of the bearing and nut of the chuck as shown in FIG. 1 in accordance with an example embodiment;

FIG. 4A illustrates a partial perspective view of the sleeve of the chuck as shown in FIG. 1 in accordance with an example embodiment;

FIG. 4B illustrates a partial perspective view of the bearing and sleeve of the chuck as shown in FIG. 1 in accordance with an example embodiment;

FIG. 4C illustrates a partial perspective view of the bearing and sleeve of the chuck as shown in FIG. 1 in accordance with an example embodiment;

FIG. 5 illustrates a perspective view of a jaw of the chuck as shown in FIG. 1 in accordance with an example embodiment;

FIGS. 6A-6C illustrate perspective and side views of a chuck body in accordance with an example embodiment;

FIG. 7 illustrates a top view of the chuck body as shown in FIG. 6 in accordance with an example embodiment;

FIG. 8 illustrates a section view of the chuck body taken along line A-A in FIG. 7 in accordance with an example embodiment;

FIGS. 9A and 9B illustrate zoomed views of a portion of the chuck body shown in FIG. 8 in accordance with an example embodiment;

FIG. 10 illustrates a chuck on a powered tool driver in accordance with an example embodiment, and

FIG. 11 illustrates a flow chart of a method of making a chuck body according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to some example embodiments, an improved chuck body for use in a power tool, such as a power driver, is provided. The body of the chuck may be the component of the chuck that directly engages with a drive shaft. The body may also include passageways for the moveable jaws that hold a bit (or end effector). In this regard, for example, a body component of the chuck may be selectively hardened to reduce or eliminate the deformation of the chuck that results from high torque events that can cause deformation of the body of the chuck. More specifically, the posterior section (or portion) of the body of the chuck may be hardened to counteract the effect of the high torques that may be applied to the body chuck associated with the engagement with the drive shaft. As a result of the hardening of the posterior section of the body, and in some example embodiments only the posterior face of the body, the useful lifetime of the chuck is increased because the hardening reduces or eliminates effects of high torque related stresses on the body, which can cause deformation and failure of the chuck.

The material used to form the body may be carbon steel, steel, or a steel alloy. For example, a medium-carbon steel or a high-carbon steel may be used. This material may be acted upon by a treatment process that involves, for example, induction hardening (also referred to as a high frequency or induction quenching), possibly with other treatments to perform the hardening. As a result of these operations, a hardened and more resilient posterior portion of the body may be formed as a reinforced surface layer. Accordingly, the hardness of the material at this layer may be higher than the hardness of the material elsewhere in the body. The layer may be formed to have a desired depth by controlling various treatment parameters. A desired depth or thickness of the layer may be selected based on, for example, testing to determine optimal performance and lifetime of the body and ultimately, the chuck.

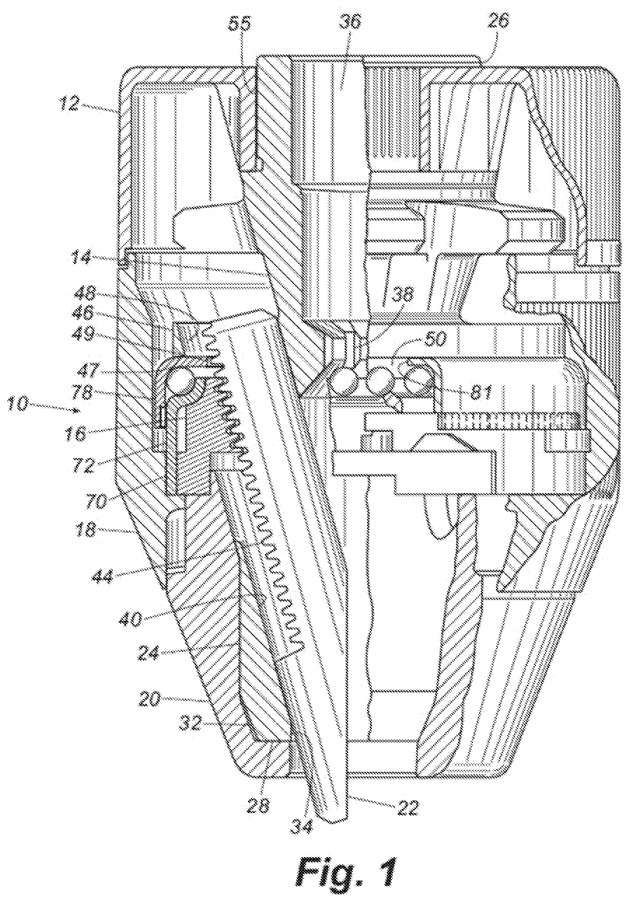

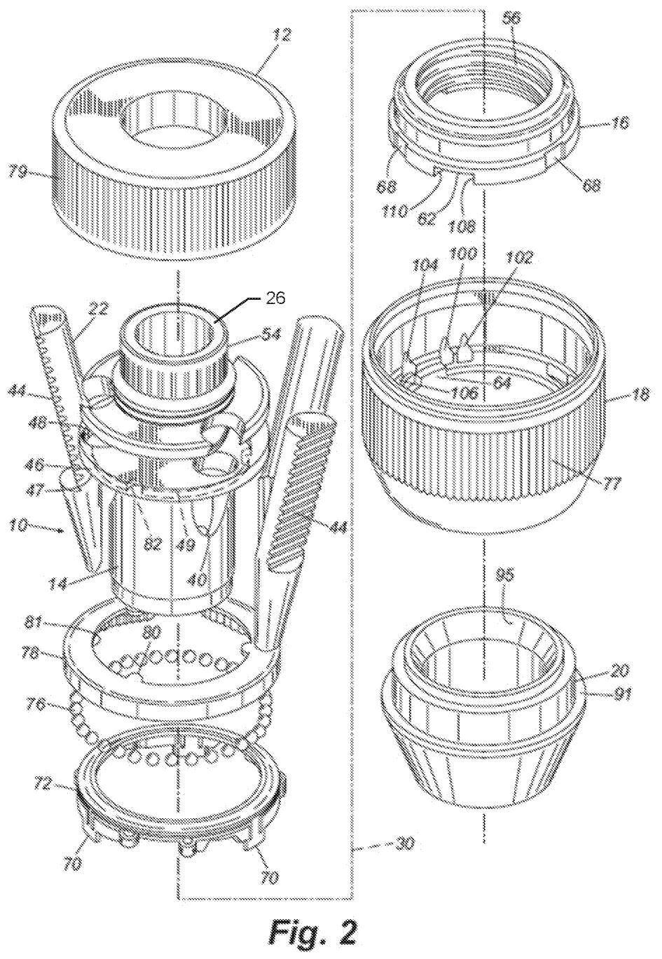

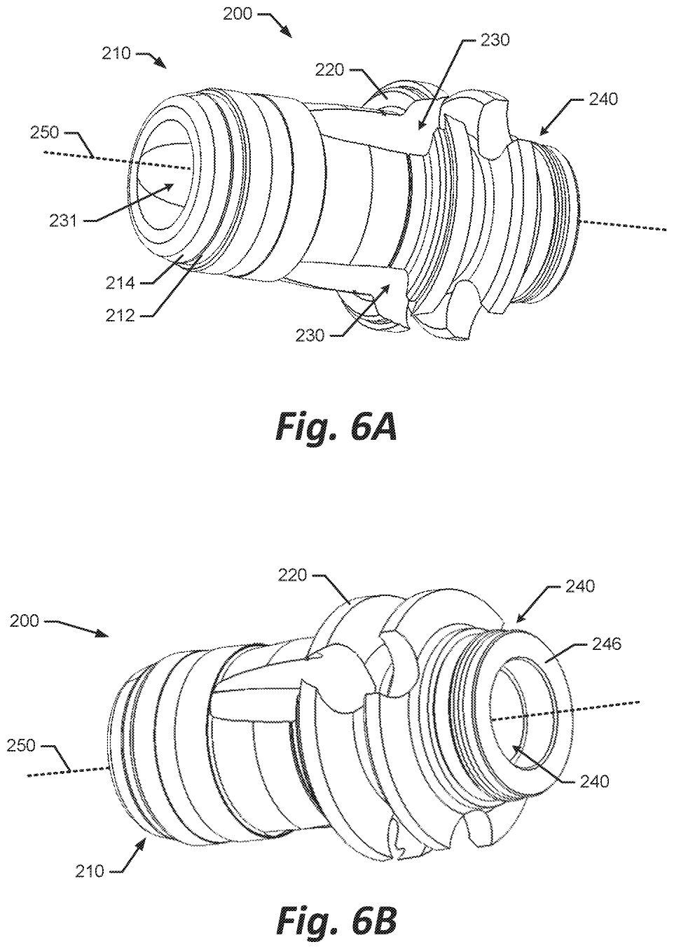

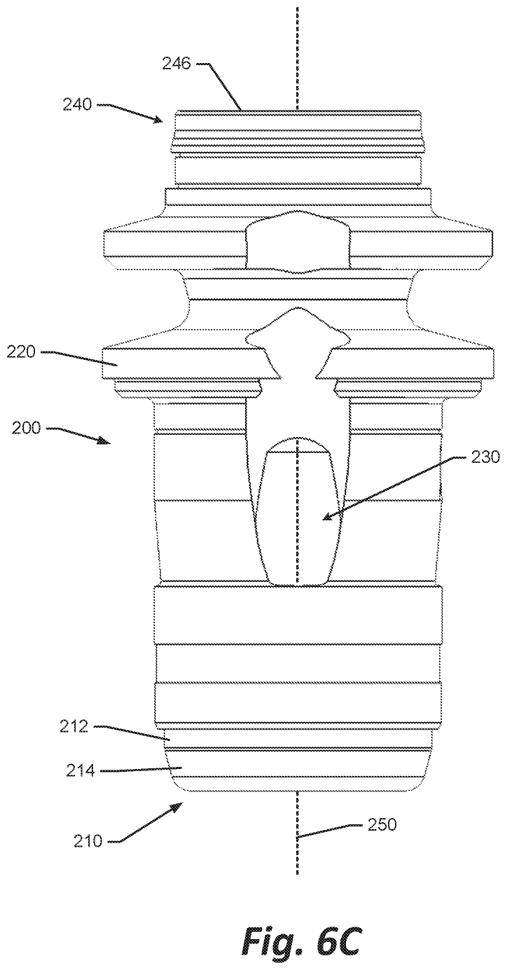

Referring to FIGS. 1 and 2, a chuck 10 includes a body 14, a nut 16, a front sleeve 18, a nose piece 20 and a plurality of jaws 22. Body 14 may be generally cylindrical in shape and may be formed from metal such as steel, aluminum, or other suitably material, including those describe herein with respect to the body 14 and the body 200 (FIGS. 6-9). Body 14 may include a nose or forward section 24 and a posterior section 26. Nose section 24 may include a front face 28 transverse to the longitudinal center axis 30 of body 14 and a tapered surface 32 at its forward end. The nose section 24 may define an axial bore 34 that may be dimensioned somewhat, for example larger than the largest tool shank that the chuck 10 may be designed to accommodate. In some embodiments, a posterior bore 36 may be formed in posterior section 26 and may be of a sized to mate with the drive shaft of a power driver. The posterior bore 36 may be cylindrical, have a taper (e.g., a partial cone-shape), or may include threading for engaging with a drive shaft that may be tapered, threaded, or the like. The bore 36 may be a tapered bore of a size to mate with a tapered drive shaft. The bores 34, 36 may, but need not, meet at a central region 38 of body 14.

Body 14 may define three passageways 40 to accommodate, for example, three jaws 22. Each jaw 22 may be separated from the adjacent jaw 22 by an angle of approximately 120 degrees. In some example embodiments, the axes of passageways 40 and jaws 22 may be angled with respect to the chuck 10 center axis 30 such that each passageway axis travels through axial bore 34 and intersects axis 30 at a common point ahead of the body 14. The jaws 22 may form a grip that moves radially toward and away from the center axis 30 to grip a bit, and each jaw 22 may have a tool engaging face generally parallel to the axis 30. According to some example embodiments, the nut 16 may rotate relative to the center axis 30. Threads 44, formed on the opposite or outer surface of jaws 22, may be constructed in any suitable type and pitch. As shown in FIG. 5, each jaw 22 may be formed with carbide inserts 112 pressed into its tool-engaging surface.

As illustrated in FIGS. 1 and 2, body 14 may include a thrust ring 46 that may be integral with the body 14. It should be understood, however, that thrust ring 46 and body 14 may be separate components. Thrust ring 46 may include a plurality of jaw guideways 48 formed around its circumference to permit retraction of jaws 22 therethrough. Thrust ring 46 may also include a ledge portion 50 to receive a bearing assembly, as described below.

Body posterior section 26 may include a knurled surface 54 that receives an optional rear sleeve 12 (or dust cover) in a press fit at 55. Rear sleeve 12 may also be retained by press fit without knurling, by use of a key or by crimping, staking, riveting, threading or any other suitable securing mechanism. Further, the chuck 10 may be constructed with a single sleeve having no rear sleeve 12.

Nose piece 20 may retain nut 16 against forward axial movement. The nose piece 20 may be press fit to body nose section 24. It should be understood, however, that other methods of axially securing the nut 16 on the body 14 may be used. For example, the nut 16 may be a two-piece nut held on the body 14 within a circumferential groove on the outer circumference of the body 14. Nose piece 20 may be coated with a non-ferrous metallic coating to prevent rust and to enhance its appearance. Examples of suitable coatings include, without limitation, zinc or nickel, although it should be appreciated that any suitable coating could be utilized.

The outer circumferential surface of front sleeve 18 may be knurled or may be provided with longitudinal ribs 77 or other protrusions to enable the operator to grip it securely. In like manner, the circumferential surface of rear sleeve 12, if employed, may be knurled or ribbed as at 79 if desired.

Front sleeve 18 may be secured from movement in the forward axial direction by an annular shoulder 91 on nose piece 20. A frustoconical section 95 at the rearward end of the nose piece facilitates movement of jaws 22 within the chuck 10.

The front sleeve 18 and/or rear sleeve 12 may be molded or otherwise fabricated from a metal, a metal alloy, or a structural plastic such as polycarbonate, a filled polypropylene, for example a glass filled polypropylene, or a blend of structural plastic materials. Other composite materials such as, for example, graphite filled polymerics may also be suitable in certain environments. As should be appreciated by one skilled in the art, the materials from which the chuck 10 may be fabricated may depend on the end use of the chuck 10, and the above materials are provided by way of example only.

Nut 16 has threads 56 for mating with jaw threads 44. Nut 16 may be positioned about the body 14 in engagement with the jaw threads 44 so that when the nut 16 may be rotated with respect to body 14, the jaws 22 will be advanced or retracted depending on the rotational direction of the nut 16.

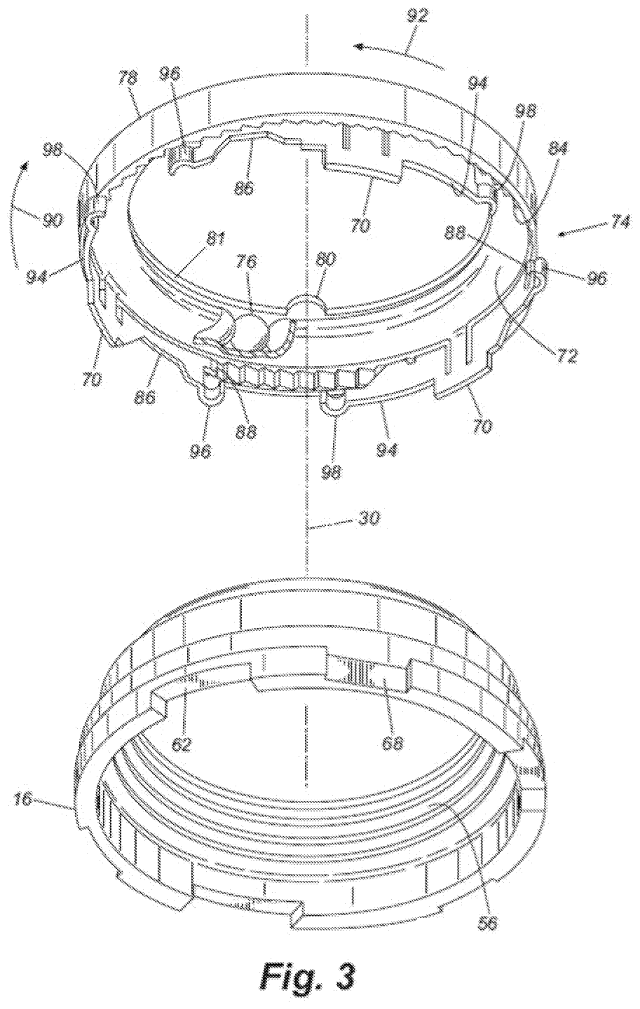

As illustrated in FIG. 3, the forward axial face of the nut 16 includes nut grooves 62 that receive respective drive dogs 64 (FIG. 2) extending from the inner surface of front sleeve 18. The angular width of the drive dogs 64 may be less than that of the nut grooves 62, resulting in a slight range of relative rotational movement, for example between 4 degrees and 30 degrees, between the nut and the front sleeve 18.

Nut 16 may also define a plurality of grooves formed as flats 68 about the outer circumference of nut 16. Flats 68 may receive respective tabs 70 extending forward from an inner race 72 of a bearing assembly 74. The engagement of tabs 70 and flats 68 may rotationally fix the inner race 72 to the nut 16, although it should be understood that there may be a slight rotational tolerance between the tabs 70 and flats 68. According to some example embodiments, the inner race 72 may operably couple to the nut 16 at surface 49 and may operably couple to bearing elements at 47. Further, the inner race 72 may include an inner edge 81.

Inner race 72 may receive a plurality of bearing elements, in this example bearing balls 76, disposed between the inner race 72 and an outer race 78 seated on thrust ring ledge 50 (FIG. 1). Outer race 78 may be rotationally fixed to body 14 by a plurality of tabs 80 received in corresponding grooves 82 in the thrust ring ledge.

Outer race 78 may also include a ratchet. In the illustrated embodiment, the ratchet may be formed by a plurality of sawtooth-shaped teeth 84 disposed about the inner circumferential surface of the outer race 78. A first pawl 86 may extend from one side of each tab 70 and may be biased radially outward from the inner race 72, thereby urging a distal end 88 of each pawl 86 toward the outer race ratchet.

Each tooth 84 may have a first side with a slope approaching 90 degrees. The second side of each tooth 84 may have a lesser slope. Pawl 86 may be deflectable and may be generally disposed in alignment with the slope of the second side. Thus, rotation of inner race 72 in a closing direction 90 with respect to outer race 78 may move pawl distal ends 88 repeatedly over teeth 84, causing a clicking sound, as ends 88 fall against each subsequent tooth's second side. This configuration of teeth 84 and pawl 86, however, may prevent the rotation of the inner race 72 in an opening direction 92. Application of rotational force to the inner race 72 in the opening direction 92 forces distal ends 88 into the steep-sloped first sides of teeth 84. Since pawl 86 may be generally perpendicular to the first sides, pawl 86 need not deflect inward to permit rotation.

As discussed below, closing direction 90 corresponds to the tightening of jaws 22, while opening direction 92 corresponds to loosening of the jaws 22. Accordingly, when pawls 86 engage ratchet teeth 84, the teeth may permit the movement of the inner race 72 in the opening direction 92, but prevent the movement of the inner race 72 in the closing direction 90.

A second deflectable pawl 94 may extend to the other side of each tab 70. Like pawls 86, each pawl 94 may be biased radially outward. Unlike pawls 86, however, pawls 94 may not engage the outer race ratchet.

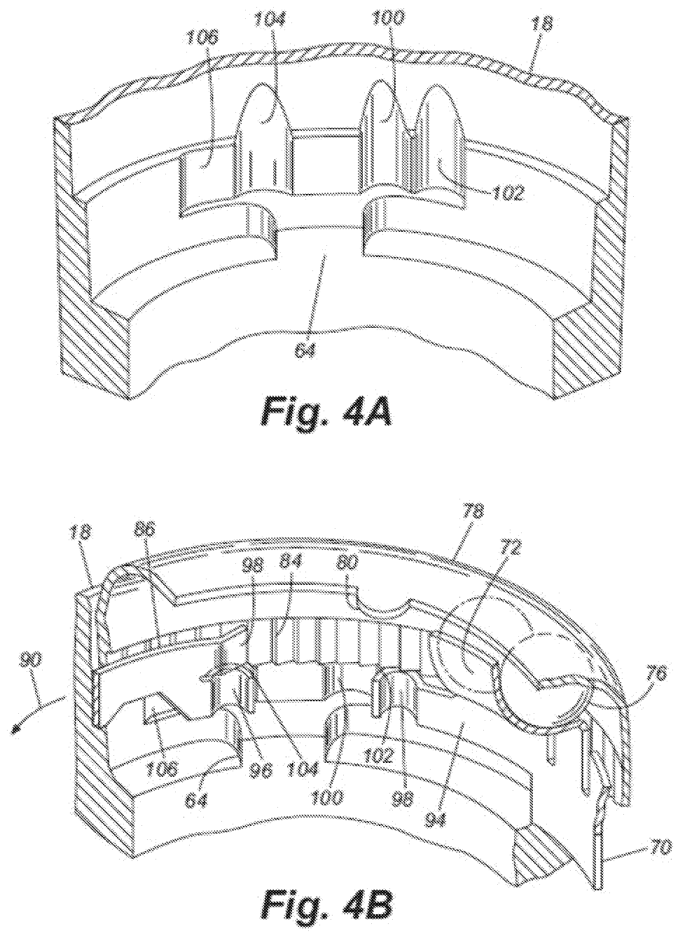

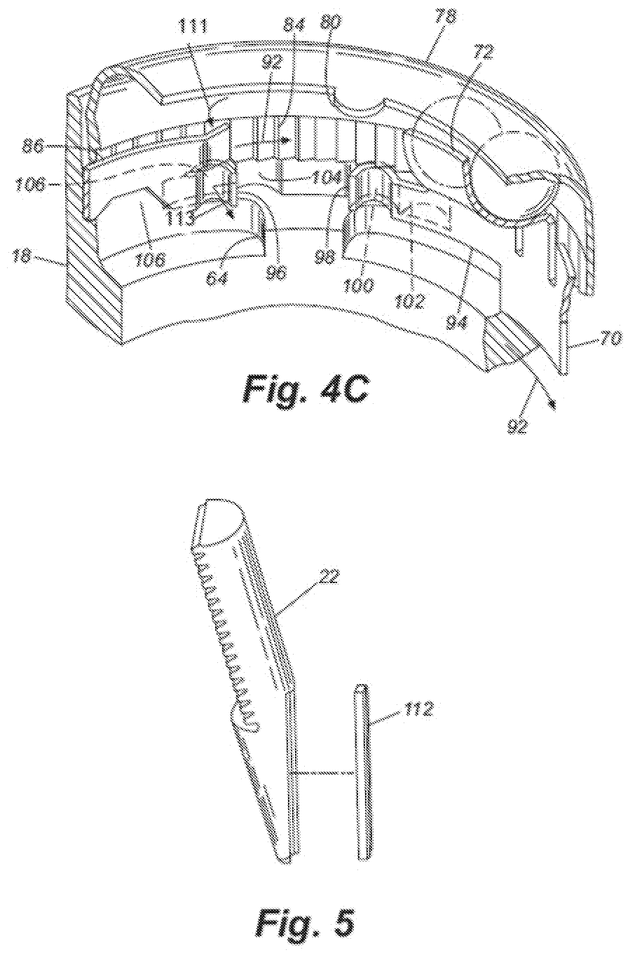

Pawls 86 and 94 may include tabs 96 and 98 at their distal ends. Referring also to FIG. 4A, an inner circumferential surface of front sleeve 18 may define first and second recesses 100 and 102. During the operation, each tab 98 may be received in one of these recesses 100,102, depending on the rotational position of the front sleeve 18 with respect to the nut 16, as discussed in more detail below. The front sleeve 18 may also define a third recess 104 and a cam surface 106. Also depending on the rotational position of the front sleeve, each tab 96 may be received either by the cam surface or by recess 104. The front sleeve 18 may include the pair of recesses 100, 102 for each tab 98 and a recess 104 and cam surface 106 for each tab 96.

FIG. 4C illustrates the disposition of pawls 86 and 94 when front sleeve 18 may be in a first of two positions with respect to nut 16 (FIG. 2), while FIG. 4B illustrates these components when the front sleeve 18 is in a second position with respect to the nut 16. For ease of illustration, both FIGS. 4B and 4C omit the nut 16. However, referring to FIG. 2 and to the second position of the front sleeve 18, as shown in FIG. 4B, each drive dog 64 may be disposed against or adjacent to a first engagement edge 108 of the nut groove 62 in which each drive dog 64 may be received. Each of the recesses 102 of front sleeve 18 may receive tab 98 of one of the pawls 94, and each recess 104 receives tab 96 of one of the pawls 86. Accordingly, the distal end 88 of each pawl 86 may engage ratchet teeth 84, and inner race 72 may rotate only in the opening direction 92 with respect to outer race 78.

Referring now to FIG. 4C. when inner race 72 moves in the opening direction 92 with respect to the outer race 78, each tab 98 moves out of recess 102 and into recess 100, as indicated by arrow 111. Each tab 96 rides up and out of its recess 104 onto its cam surface 106, as indicated by arrow 113. As indicated by arrow 112, the tabs 96 riding up and out of recesses 104 may push each deflectable tab 86 radially inward, thereby disengaging distal ends 88 from ratchet teeth 84. Thus, the inner race 72 may be free to rotate with respect to the outer race 78.

When front sleeve 18 rotates in the opening direction 92, so that the inner race 72 moves from the position shown in FIG. 4B to the position shown in FIG. 4C, drive dogs 64 may move within nut grooves 62 of nut 16 (FIG. 2). As a result, each drive dog 64 may be against or immediately adjacent to a second engagement edge 110 of the nut groove 62.

In operation, and referring to FIGS. 2m 3, 4B and 4C, nut grooves 62 receive drive dogs 64 when the chuck 10 may be between fully opened and fully closed positions so that the drive dogs 64 are adjacent the first engagement edges 108. Inner race 72 may be disposed with respect to outer race 78 so that tabs 96 and 98 are received by cam surface 106 and recess 100. respectively. Front sleeve 18 may be in the first position with respect to the nut 16. In this condition, tabs 98 and recesses 100 rotationally fix inner race 72 to front sleeve 18. Since inner race 72 may be rotationally fixed to nut 16 by tabs 70 and flats 68, an operator rotating front sleeve 18 rotationally drives the nut through inner race 72, thereby opening or closing the jaws 22. When the operator rotates the front sleeve 18 in the closing direction 92 to the point that the jaws 22 tighten onto a tool shank, the nut 16 may be urged rearward up the jaw threads 44, thereby pushing the nut against inner race 72, bearing elements 76, outer race 78 and thrust ring 46. The rearward force creates a frictional lock between the nut 16 and inner race 72 that further rotationally fixes the nut 16 and inner race 72.

The wedge between the nut threads 56 and jaw threads 44 increasingly resists the rotation of nut 16. When the operator continues to rotate front sleeve 18, and the resistance overcomes the hold provided by tabs 98 in recesses 100, front sleeve 18 rotates with respect to nut 16 and inner race 72. This moves drive dogs 64 from second engagement edge 110 to the first engagement edge 108 of nut grooves 62 and pushes tabs 98 out of recesses 100 into recesses 102. Simultaneously, cam surfaces 106 rotate away from tabs 96 so that the tabs 96 are released into recesses 104, thereby engaging distal ends 88 of pawls 86 with ratchet teeth 84, as shown in FIG. 4B. At this point, inner race 72, and therefore nut 16, may be rotationally locked to outer race 78 and body 14, against rotation in the opening direction 92. In other words, the nut 16 may be rotationally locked to the body 14 in the opening direction 92. Since the rotation of the nut 16 with respect to the body 14 may be necessary to open the jaws 22 of the chuck 10, the rotational locking of the nut 16 may prevent inadvertent opening during use.

Inner race 72, and therefore nut 16, may, however, still rotate with respect to outer race 78, and therefore body 14, in the closing direction 90. During rotation in the closing direction 90, front sleeve 18 may drive nut 16 through drive dogs 64 against first engagement edge 108, as well as through inner race 72. Further rotation of the front sleeve 18 in the closing direction 92 may continue to tighten the chuck 10 and, as described above, may produce a clicking sound to notify the operator that the chuck 10 is in a fully tightened position.

To open the chuck 10, the operator may rotate front sleeve 18 in the opening direction. Front sleeve 18 transfers torque to inner race 72 at the engagement of tabs 96 and 98 in recesses 104 and 102, respectively. Because pawls 86 engage outer race 78, which may be rotationally fixed to the body, through the ratchet teeth, the inner race 72 may not rotate with the front sleeve 18. Thus, upon application of sufficient torque in the opening direction 92, front sleeve 18 moves with respect to the inner race 72 and the nut 16. Rotating the front sleeve 18 in the opening direction 92 may move tabs 96 back up onto cam surfaces 106, thereby disengaging pawls 86 from ratchet teeth 84. Tabs 98 may move from recesses 102 into recesses 100, and drive dogs 64 move from the first engagement edges 108 to the second engagement edges 110 of the nut grooves 62. Thus, the front sleeve 18 may move to its first position with respect to the nut 16, as shown in FIG. 4C, and the inner race 72 and nut 16, are free to rotate with respect to the outer race 78 and body 14. Accordingly, further rotation of front sleeve 18 in the opening direction 92 may move jaws 22 away from the enter axis 30, thereby opening the chuck 10.

Having described the components and operation of an example chuck, a discussion of the hardening of the body of the chuck will now be described having the context provided above. In some embodiments, the chuck 10, and therefore the body 14, may be subjected to sudden, repeated, and extended applications of high torque rotational forces. For the body 14 to be durable and effective over time, the body 14, according to some example embodiments, may be designed for certain levels of strength, toughness, and hardness (e.g., surface hardness). The strength is indicated by the body's ability to be subjected to high torque. Toughness of a chuck body 14 may be indicated by the duration of the fatigue life of the body 14. Finally, hardness, and more specifically, surface hardness is indicated by the body's resistance to deformation. According to some example embodiments, the treatment processes used in conjunction with the materials to form a body 14, as described herein, can be designed for certain levels of strength. toughness, and hardness. Accordingly, a body 14 with increased durability, according to some example embodiments, may be realized that exhibits increased tolerance to high torque, longer fatigue life, and improved deformation resistance.

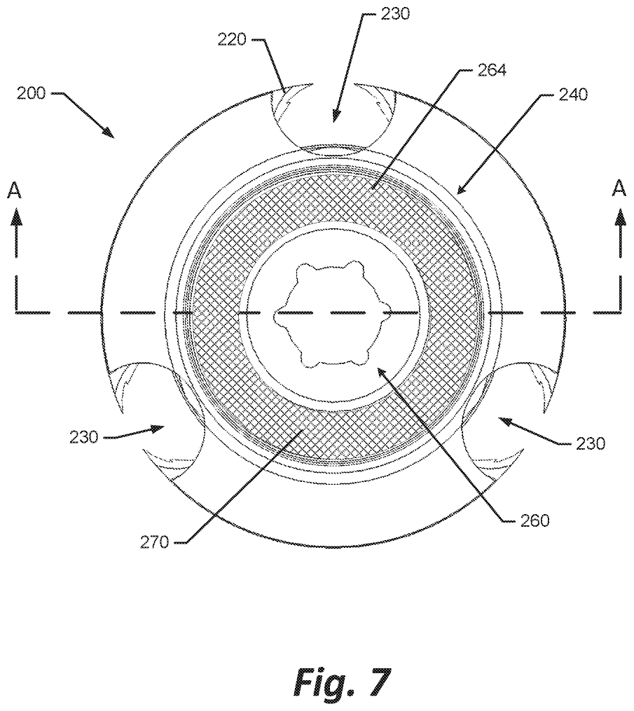

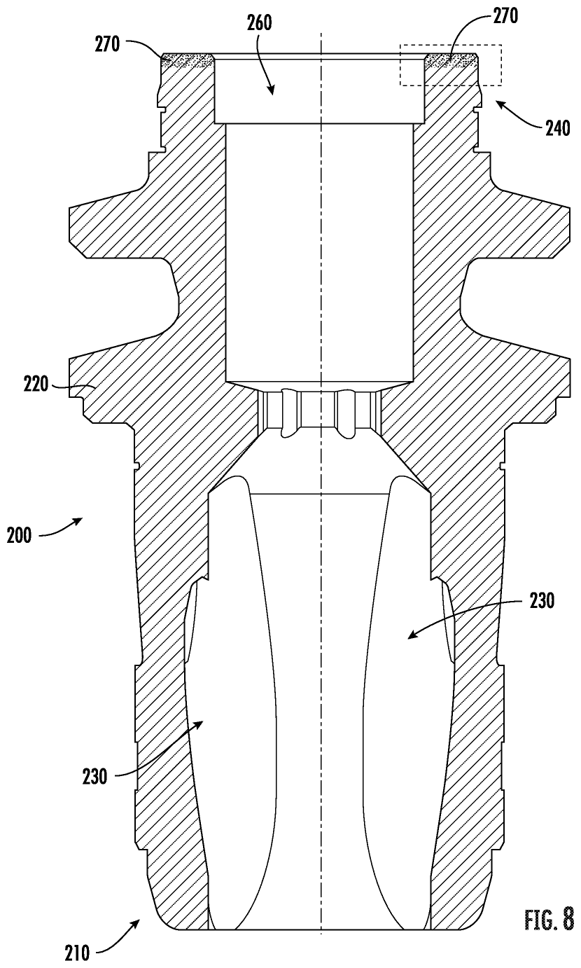

Now referring to FIGS. 6-9, an example embodiment of a body 200 of a chuck (such as chuck 10) is shown in a various views. FIG. 6A shows a perspective front view of the chuck 200 and FIG. 6B shows a perspective back view of the chuck 200. FIG. 6C provides a side view of the chuck 200 and FIG. 7 shows a back or rear view of the chuck 200. The body 200 may be the same or similar to the body 14 described above and may be implemented within a chuck 10 in the same manner as described.

In this regard, the body 200 may include a nose or forward section 210, a thrust ring 220, a plurality of passageways 230, and a posterior section 240. According to some example embodiments, the component of the body 200 may be machined from a blank, and therefore the components may be integrated in to a single component. The forward or nose section 210 may include a front face 212 transverse to the longitudinal center axis 250 of body 200 and a tapered surface 214 at its forward end. The nose section 240 may include a forward bore 231 formed about the axis 250. The plurality of passageways 230 may be formed in the body 200 such that the passageways 230 intersect into the forward bore 231.

The posterior section 240 may extend from the forward section 210 along a central axis 250 in a rearward direction. According to some example embodiments, the posterior section 240 may have a cylindrical shape. The posterior section 240 may include a posterior bore 260 and a posterior face 246 that surrounds the posterior bore 260. The posterior face 246 may be a planar surface and may be ring-shaped. In this regard, according to some example embodiments, the posterior section 240 may include an external cylindrical surface and internal cylindrical surface with the posterior face 246 extending between the internal and external surfaces. A distance from the internal surface to the external surface (i.e., a width of the posterior face 246) may also define a thickness of the posterior section 240.

In some embodiments, a posterior bore 260 may be of an appropriate size to mate with the drive shaft of a power driver. As mentioned above the posterior bore 260 may be tapered and/or the drive shaft may be tapered to increase the engagement between the posterior bore 260 and the drive shaft. In this regard, the posterior section 240 may be a section of the body 200 that experiences high torque rotational forces. As such, the posterior section 240 of the body 200 or select portions of the posterior section 240 (e.g., the posterior face 264) may be treated, in accordance with some example embodiments, with an induction hardening process to improve an ability to receive high torque loads and resist deformation.

According to some example embodiments, the body 200 may be formed of a material such as steel or a steel alloy. The type of material used, and subjected to treatment processes as described herein, may result in a posterior section 240 of the body 200 that is designed for certain levels of strength, toughness, and surface hardening. In this regard, the material used to form the body 200 may be, for example, a medium-carbon steel or high-carbon steel. A medium-carbon steel may be a steel alloy that has a carbon content between, for example, 0.26% to 0.60% by weight. A high-carbon steel may be a steel alloy that has a carbon content between, for example, 0.60% to 1% (possibly with a manganese content of 0.3% to 0.9%). According to some example embodiments, the material used for the body 200 may be steel #30, #35, #40, #45, #50, or #55. Alternatively, the material used for the body 200 may be 30Cr, 35Cr, 40Cr, or 45Cr steel. As the carbon content of steel increases, the material becomes stronger and harder. However, the material also becomes less ductile and more susceptible to cracking and fracture. As such, the use of medium-carbon steel in the context of a chuck body 200, according to some example embodiments, with example treatment processes applied to particular areas as described herein, has been shown to decrease run-out by having harder portions of the body 200 in particular locations while permitting other portions of the body 200 to still be relatively ductile and thus more fracture resistant. With that said, high-carbon steel has also showed similar benefits, however, with some increase in the risk of cracking or fracture.

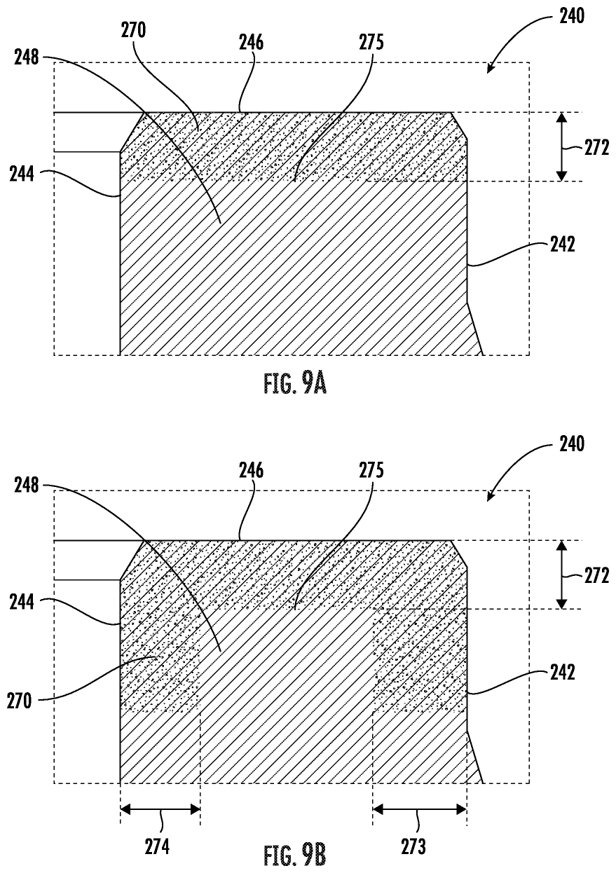

Having described the structural configuration and materials that may be used to form the example body 200, as well as the portions of the body 200 that are subjected to surface stresses during operation of a chuck 10, FIGS. 9A and 9B indicates where, according to some example embodiments, on the body 200 a treatment process may be applied to increase the hardness of the surface of the posterior section 240. In this regard, FIG. 8 is a section view of the body 200, taken along line A-A from FIG. 7, where the hatched areas indicate the internal material comprising the structure of the body 200. FIGS. 9A and 9B present a zoomed view of the posterior section 240 of the body 200 shown in FIG. 8. In FIG. 9A, a different pattern of hatching has been used to differentiate portions of the body 200 where a treatment process may be applied from untreated portions of the body, according to some example embodiments. In some embodiments the entire body 200 may have a hardening process performed thereon, and an additional treatment process may also be applied to only select portions of the body 200.

Posterior section 240 may be disposed at a distal end of the body 200 relative to the nose section 210. As shown in FIGS. 9A and 9B, the posterior section 240 may include, according to some example embodiments, an outer side 242, an inner side 244, and a posterior face 246. According to a preferred example embodiment, the application of a treatment processes may be restricted to the posterior face 246 as shown in FIG. 9A. In some other example embodiments, the application of a treatment processes may extend about a perimeter of the posterior section 240 that may include the outer side 242, the inner side 244, and the posterior face 246 as shown in FIG. 9B. As mentioned above, the posterior section 240 may be the only section of the body 200 that is hardened, and in this regard, no other section of the body 200 may be treated with a hardening process. In doing so, the hardened posterior section 240 or posterior face 246 can increase the strength and toughness of a portion of the body 200 that is subjected to high torque events and undesired deformation due to the engagement with the drive shaft, while permitting other portions of the body 200 to be relatively ductile and thus more fracture resistant.

Accordingly, via the treatment process, a hardened layer 270 may be formed only in the posterior face 246 of the posterior section 240 as shown in FIG. 9A. As such, according to some example embodiments, the hardened layer 270 may be ring-shaped. Further, the hardened layer 270 may be radially symmetric about the center axis 250 and may extend around at least a portion of an engaging surface with the drive shaft. The hardened layer 270 may extend to a posterior depth 272 from the posterior face 246 in to the material of the body 200. The posterior depth 272 may be a function of the parameters of the treatment process as further described below. Accordingly, the hardened layer 270 may extend into the material of the posterior section 240 from the posterior face 246 to an internal region 248 of the posterior section 240. A transitional interface 275 may define the depth 272 at which the hardened layer 270 transitions into the internal region 248 of the posterior section 240 and the hardness of the material changes. In this regard, the hardness of the material within the hardened layer 270 is greater than the hardness of the internal region 248. Additionally, according to some example embodiments, the hardness of the material within the hardened layer 270 may be greater than the hardness of the nose section 240. According to some example embodiments, the posterior face 246 may be the only surface subjected to hardening because the side surfaces of the drive shaft, such as a tapered drive shaft, may provide a radial force on the interior of the posterior bore 260. As such, according to some example embodiments, it may be beneficial to maintain a degree of malleability in the material being subjected to such forces to reduce the risk of fracture and increase surface-to-surface engagement.

In some embodiments, the hardened layer 270 may also be formed in the outer side 242 and the inner side 244 in addition to the posterior face 246 as shown in FIG. 9B. In this regard, the hardened layer 270 may extend from the outer side 242 to an outer depth 273, and from the inner side 244 to an inner depth 274 into the material of the posterior section 240. Accordingly, the hardened layer 270 may extend from the outer side 242, the inner side 244, and the posterior face 246, toward an internal region 248 of the posterior section 240. In some embodiments, the posterior depth 272, the outer depth 273 and the inner depth 274 may all extend the same distance from the surface of the posterior section 240 towards the internal region 248. In another example embodiment, the posterior depth 272, the outer depth 273 and the inner depth 274 may all extend different distances from the surface of the posterior section 240 towards the internal region 248. In some cases, the posterior depth 272 may be greater than the outer depth 273 and the inner depth 274. In further embodiments, the posterior depth 272 may be less than the outer depth 273 and the inner depth 274.

A hardened layer transitional material interface 275 may define the depth (272, 273, and 274) at which the hardened layer 270 transitions into the internal region 248 of the posterior section 240 and the hardness of the material changes. According to some example embodiments, the transition at the hardened layer transitional material interface 275 may be gradual, and may therefore be defined by a gradient. The hardened layer 270 may have a first hardness that is greater than a second hardness of the internal region 248 of the posterior section 240 and other non-hardened portions of the body 200 (e.g., the nose section 240). According to some example embodiments, the first hardness, i.e., the hardness of the hardened layer 270, may be within a range from about HRC 25 to about HRC 55, or within a range from about HRC 30 to about HRC 52, or within a range from about HRC 35 to about HRC 50. According to some example embodiments, the first hardness may be less than HRC 60, but greater than HRC 25 or HRC 30. According to some example embodiments, the first hardness may be about HRC 50.

According to some example embodiments, the second hardness, i.e., the hardness of the internal region 248 of the posterior section 240 and other non-hardened portions of the body 200 (e.g., the nose section 240) may be within a range from about HRB 70 to about HRB 100, or within a range from about HRB 80 to about HRB 90, or within a range from about HRB 65 to about HRB 105, or within a range from about HRB 80 to about HRB 100. According to some example embodiments, the second hardness may be less than about HRB 100 or less than about HRB 90.

In this regard, the hardened layer depth (272, 273, and 274) may be, according to some example embodiments, within a range from about 0.2 millimeters (0.0078 inches) to about 1.27 millimeters (0.050 inches). Alternatively, according to some example embodiments, the hardened layer depth may be within a range from about 0.2 millimeters to about 1.3 millimeters. According to still some other embodiments, the hardened layer depth may be within a range from about 0.15 millimeters to about 0.5 millimeter. In some other cases, the hardened layer depth may be within a range from about 0.3 millimeters to about 0.75 millimeters.

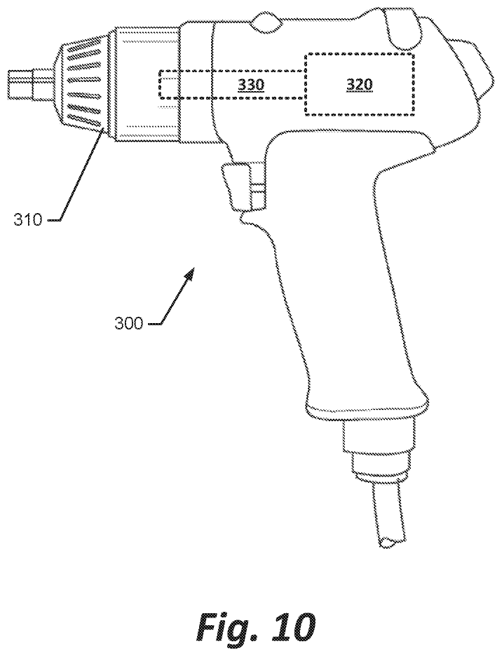

FIG. 10 depicts a power tool 300 with a chuck 310 affixed thereto, according to an example embodiment. In this regard, the power tool 300 may include a drive motor 320 and a drive shaft 330. The drive shaft 330 may operably couple the drive motor 320 to the chuck 310. The drive shaft 330 may interface with a posterior bore in the chuck 310, similar to the posterior bore 260 of the body 200. The chuck 310 may operably couple an end effector (e.g, a drill bit) (not shown) to the power tool 300, and may transfer torque to the end effector from the drive motor 320. The chuck 310 may be the same or similar to the chuck 10, and may include a body that is the same or similar to the body 14 or the body 200 with a hardened posterior section or face. The drive shaft 330 may therefore transfer torque produced by the drive motor 320 to the chuck 310 in order to drive the end effector. In some embodiments, the power tool 300 may be electrically driven, while in some other embodiments a power tool 300 of any suitable type may be utilized.

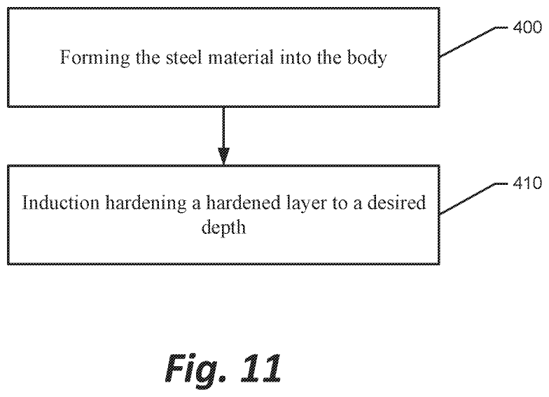

Having described the structure of the body 200 and the features resulting from example treatment processes described herein. FIG. 11 provides a flow chart for a method of making the body 200 that comprises performing example treatment processes to form the hardened layer 270. According to some example embodiments, at 400, a steel material may be cut to a workable size for making the body 200, and machined into the shape of the body 200. According to some example embodiments, the steel material may be a medium-carbon steel.

Subsequently, at 410, induction hardening (also referred to as high frequency or induction quenching) may be performed to form the hardened layer 270. In this regard, via the induction hardening, the hardened layer 270 may be hardened to a first hardness that is greater than the hardness of the material elsewhere in the body 200, which has a second hardness that is less than the first hardness. The induction hardening process may be performed to realize the depths (272, 273, 274) of the hardened layer 270 described above. Further, the induction hardening may involve heating or cooling, according to some example embodiments, only the necessary area of the body 200 at the posterior section 240 by using a high-frequency electrical current (e.g., with a frequency of 10 kHz to 1000 kHz) to form the hardened layer 270. The temperature may also be controlled during the induction hardening process. The induction hardening process may create, at these locations, a surface hardened layer (e.g., layer depth ranging from about 0.5 millimeters to about 5 millimeters or other depths as described herein) with higher hardness and improved deformation resistance. As a result of the induction hardening, the hardened layer 270 may be formed while the other portions of the body 200, including the interior region 248, maintain their structure.

Subsequent to performing induction hardening a shot peening operation may be performed, which is also optional. The shot peening may form a compressive stress layer on the exterior of the body 200. Additionally, any final machining or grinding of the body 200 may be performed.

Having describe various aspect of some example embodiments, additional example embodiments will not be provided and various combinations thereof. In this regard, in accordance with a first embodiment, a chuck for use with a powered driver having a rotatable drive shaft is provided. The chuck may comprise a plurality of jaws and a body comprising a forward bore, a plurality of passageways, and a posterior bore. The plurality passageways may intersect into the forward bore and the plurality of jaws may be movably disposed within the plurality of passageways. The posterior bore may be disposed in a posterior section of the body and the posterior bore may be configured to receive the drive shaft to couple the drive shaft with the chuck. The chuck may also comprise a nut operably coupled to the jaws such that rotation of the nut relative to the body moves the jaws relative to the body in an opening or closing direction. Additionally, a hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

In accordance with a second embodiment, the hardened layer depth may be within a range from about 0.2 millimeters to about 1.3 millimeters. The second embodiment may be combined with first embodiment. In accordance with a third embodiment, the hardened layer depth may be within a range from about 0.5 millimeters to about 1 millimeter. The first embodiment may be combined with first embodiment. In accordance with a fourth embodiment, the posterior face and the hardened layer may be ring-shaped. The fourth embodiment may be combined with any or all of embodiments one to three, as appropriate. In accordance with a fifth embodiment, the hardened layer may be radially symmetric about a central axis of the chuck. The fifth embodiment may be combined with any or all of embodiments one to four, as appropriate. In accordance with a sixth embodiment, the hardened layer may extend around at least a portion of an engaging surface with the drive shaft. The sixth embodiment may be combined with any or all of embodiments one to five, as appropriate. In accordance with a seventh embodiment, the first hardness may be within a range from about HRC 30 to about HRC 52. The seventh embodiment may be combined with any or all of embodiments one to six, as appropriate. In accordance with an eighth embodiment, the first hardness may be within a range from about HRC 25 to about HRC 55. The eighth embodiment may be combined with any or all of embodiments one to six, as appropriate. In accordance with a ninth embodiment, the first hardness may be within a range from about HRC 35 to about HRC 50. The ninth embodiment may be combined with any or all of embodiments one to six, as appropriate. In accordance with a tenth embodiment, the first hardness may be within a range from about HRC 30 to about HRC 52, and the second hardness may be within a range from about HRB 70 to about HRB 100. The tenth embodiment may be combined with any or all of embodiments one to six, as appropriate. In accordance with an eleventh embodiment, the body may be constructed of medium-carbon steel. The eleventh embodiment may be combined with any or all of embodiments one to ten, as appropriate.

In accordance with a twelfth embodiment, according to some example embodiments, a body for a chuck for use with a powered driver having a rotatable drive shaft is provided. The body may comprise a forward bore and a plurality of passageways intersecting into the forward bore to receive chuck jaws. The body may further comprise a posterior bore disposed in a posterior section of the body, and the posterior bore may be configured to receive the drive shaft to couple the drive shaft with the chuck. The body may define a posterior face that surrounds the posterior bore. A hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

In accordance with a thirteenth embodiment, the hardened layer depth is within a range from about 0.2 millimeters to about 1.3 millimeters. The thirteenth embodiment may be combined with the twelfth embodiment. In accordance with a fourteenth embodiment, the hardened layer depth may be within a range from about 0.5 millimeters to about 1 millimeter. The fourteenth embodiment may be combined with the twelfth embodiment. In accordance with a fifteenth embodiment, the posterior face and the hardened layer are ring-shaped. The fifteenth embodiment may be combined with any or all of embodiments twelve to fourteen, as appropriate. In accordance with a sixteenth embodiment, the first hardness may be within a range from about HRC 25 to about HRC 55. The sixteenth embodiment may be combined with any or all of embodiments twelve to fifteen, as appropriate. In accordance with a seventeenth embodiment, the first hardness may be within a range from about HRC 30 to about HRC 52, and the second hardness may be within a range from about HRB 70 to about HRB 100. The seventeenth embodiment may be combined with any or all of embodiments twelve to fifteen, as appropriate.

In accordance with an eighteenth embodiment, a power driver is provided. The power driver may comprise a drive motor and a drive shaft coupled to the drive motor to be rotationally driven by the drive motor. The power driver may further comprise a chuck coupled to the drive shaft to be rotationally driven by the drive motor via the drive shaft. The chuck may comprise a body. The body may comprise a posterior bore disposed in a posterior section of the body. The posterior bore may be configured to receive the drive shaft to couple the drive shaft to the chuck. A hardened layer may be disposed at a posterior face of the body that surrounds the posterior bore. The hardened layer may have a hardened layer depth to a transitional interface with an internal region of the posterior section. The hardened layer may have a first hardness and the internal region may have a second hardness. The first hardness may be greater than the second hardness.

In accordance with a nineteenth embodiment, the hardened layer depth is within a range from about 0.2 millimeters to about 1.3 millimeters. The nineteenth embodiment may be combined with the eighteenth embodiment. In accordance with a twentieth embodiment, the first hardness is within a range from about HRC 25 to about HRC 55. The twentieth embodiment may be combined with any or all of embodiments eighteen or nineteen, as appropriate.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A chuck for use with a powered driver having a rotatable drive shaft, the chuck comprising:
a plurality of jaws;
a body comprising a forward bore, a plurality of passageways, and a posterior bore; the plurality passageways intersecting into the forward bore and the plurality of jaws being movably disposed within the plurality of passageways, the posterior bore being disposed in a posterior section of the body and the posterior bore being configured to receive the drive shaft to couple the drive shaft with the chuck; and
a nut operably coupled to the jaws such that rotation of the nut relative to the body moves the jaws relative to the body in an opening or closing direction;
wherein a hardened layer is disposed at a posterior face of the body that surrounds the posterior bore, the hardened layer having a hardened layer depth to a transitional interface with an internal region of the posterior section;
wherein the hardened layer has a first hardness and the internal region has a second hardness;
wherein the first hardness is greater than the second hardness.

2. The chuck of claim 1, wherein the hardened layer depth is within a range from about 0.2 millimeters to about 1.3 millimeters.

3. The chuck of claim 1, wherein the hardened layer depth is within a range from about 0.5 millimeters to about 1 millimeter.

4. The chuck of claim 1, wherein the posterior face and the hardened layer are ring-shaped.

5. The chuck of claim 1, wherein the hardened layer is radially symmetric about a central axis of the chuck.

6. The chuck of claim 1, wherein the hardened layer extends around at least a portion of an engaging surface with the drive shaft.

7. The chuck of claim 1, wherein the first hardness is within a range from about HRC 30 to about HRC 52.

8. The chuck of claim 1, wherein the first hardness is within a range from about HRC 25 to about HRC 55.

9. The chuck of claim 1, wherein the first hardness is within a range from about HRC 35 to about HRC 50.

10. The chuck of claim 1, wherein the first hardness is within a range from about HRC 30 to about HRC 52; and
wherein the second hardness is within a range from about HRB 70 to about HRB 100.

11. The chuck of claim 1, wherein the body is constructed of medium-carbon steel.

12. A body for a chuck for use with a powered driver having a rotatable drive shaft, the body comprising:
a forward bore;
a plurality of passageways intersecting into the forward bore to receive chuck jaws; and
a posterior bore disposed in a posterior section of the body and the posterior bore being configured to receive the drive shaft to couple the drive shaft with the chuck
wherein the body defines a posterior face that surrounds the posterior bore;
wherein a hardened layer is disposed at a posterior face of the body that surrounds the posterior bore, the hardened layer having a hardened layer depth to a transitional interface with an internal region of the posterior section;
wherein the hardened layer has a first hardness and the internal region has a second hardness;
wherein the first hardness is greater than the second hardness.

13. The body of claim 12, wherein the hardened layer depth is within a range from about 0.2 millimeters to about 1.3 millimeters.

14. The body of claim 12, wherein the hardened layer depth is within a range from about 0.5 millimeters to about 1 millimeter.

15. The body of claim 12, wherein the posterior face and the hardened layer are ring-shaped.

16. The body of claim 12, wherein the first hardness is within a range from about HRC 25 to about HRC 55.

17. The body of claim 12, wherein the first hardness is within a range from about HRC 30 to about HRC 52; and
wherein the second hardness is within a range from about HRB 70 to about HRB 100.

18. A power driver comprising:
a drive motor;
a drive shaft coupled to the drive motor to be rotationally driven by the drive motor; and
a chuck coupled to the drive shaft to be rotationally driven by the drive motor via the drive shaft, the chuck comprising a body;
wherein the body comprises a posterior bore disposed in a posterior section of the body, the posterior bore being configured to receive the drive shaft to couple the drive shaft to the chuck;
wherein a hardened layer is disposed at a posterior face of the body that surrounds the posterior bore, the hardened layer having a hardened layer depth to a transitional interface with an internal region of the posterior section;
wherein the hardened layer has a first hardness and the internal region has a second hardness;
wherein the first hardness is greater than the second hardness.

19. The power driver of claim 18, wherein the hardened layer depth is within a range from about 0.2 millimeters to about 1.3 millimeters.

20. The power driver of claim 18, wherein the first hardness is within a range from about HRC 25 to about HRC 55.
